(19) United States
(12) Patent Application Publication
(10) Pub. No.: US 2005/0098605 A1
(43) Pub. Date: May 12, 2005

(54) Apparatus and method for low pressure wirebond

(75) Inventors: Daniel C. Edelstein, White Plains, NY (US); John A. Fitzsimmons, Poughkeepsie, NY (US); Jeffrey P. Gambino, Westford, VT (US); Anthony K. Stamper, Williston, VT (US)

Correspondence Address: DELIO & PETERSON, LLC, 121 WHITNEY AVENUE, NEW HAVEN, CT, 06510, US

(73) Assignee: International Business Machines Corporation, Armonk, NY (US)

(21) Appl. No.: 10/702,416

(22) Filed: Nov. 6, 2003

(51) Int. Cl. B23K 37/00

(52) U.S. Cl. 228/4.5

(57) ABSTRACT

A structure and method for low-pressure wirebonding, reducing the propensity of dielectric material to mechanical failure due to wirebond stress. A low temperature alloy on the surface of a bond pad allows alloy bond formation to occur between the wire and the bond pad at reduced bond pressures and reduced thermal and ultrasonic energies. Preferred alloys include Au—Sn and Au—In. The Au—Sn alloy may be formed over the Cu bond pad, incorporated in an aluminum bond pad stack, or deposited on a bond pad having Ni—Au capping of Cu or Al bond pads.

### BACKGROUND OF THE INVENTION

1. Field of the Invention

The present invention relates to wire bonding for semiconductor substrates, and more particularly to a wire bonding method and apparatus that reduces the pressure, temperature, and energy required for bonding. The present invention is particularly applicable for bonding to low-k dielectric material that is susceptible to cracking under applied pressure and temperature.

2. Description of Related Art

Semiconductor devices comprising semiconductor chips and lead frames are well known. A semiconductor integrated circuit (IC) chip having one or more semiconductor-based circuits wired by metal interconnects, with terminal inputs and outputs to external circuitry, is generally mounted on a mounting area of a lead frame, and each input/output (IO) terminal is connected with a lead of the lead frame by a thin bonding wire typically of gold or aluminum. In an integrated circuit chip, regions are usually connected to each other by interconnection on the chip, and for I/O connection with a lead outside, a special part of the interconnection called a bond pad or electrode is prepared. Generally, a bonding wire is connected to the electrode or bond pad by means of thermocompression or thermosonic bonding. Usually, to carry out the bonding, a small ball is formed at the end of the bonding wire, and then pressed onto the electrode under high temperature while the wire is excited ultrasonically.

Bonding depends upon various conditions—mechanical pressure, temperature, strength of the electrode or bond pad, power level of the added ultrasonic excitation, and time, among other factors. One type of failure is produced by the ball at the end of the bonding wire, which, being mechanically hard brings about structural deformation and destruction of the substrate upon compression. Another type of failure is pulling out or delamination of pads and associated material underneath pads as the wire is pulled off the spool after the first end is bonded to the pad. This could be the result of tensile pulling of the wire, or exacerbated by brittle fracture damage under the pad during the compression phase of bonding. A typical method for bonding a thin metal wire by ultrasonic thermocompression bonding is the so-called on-element bonding. In this method, a thin metal wire is ultrasonically thermocompression-bonded to an electrode formed adjacent to an impurity region that is formed to constitute a functional element. This method, however, has problems in that distortions or cracks are generally produced in the electrode or substrate. As is presently known in the art, low-k dielectric materials are easily damaged during wire bond operations. Insertion of a wire bond may cause excessive forces that could otherwise distort, stress, or crack the pad and underlying substrate material. Furthermore, the strength of the bond is jeopardized if micro cracks are introduced during the bonding process.

Generally, copper is used as an interconnect material in semiconductor devices. However, since copper has a tendency to corrode when exposed to environmental conditions, when used in interconnect metallurgy to diffuse into surrounding dielectric materials, such as silicon dioxide, capping of the copper is essential. A barrier layer is normally provided to the top surface of the copper to inhibit diffusion. However, some barrier layers are subject to delaminating under conditions of mechanical loading. Moreover, a wire bonded to a barrier layer that is structurally deficient provides a weak contact point that ultimately jeopardizes the semiconductor's integrity and reliability. Making a stronger bond would generally require increasing bond pressure, ultrasonic energy, and temperature so that the wire is sufficiently attached to the barrier layer.

In U.S. Pat. No. 6,133,136 issued to Edelstein, et al., on Oct. 17, 2000, entitled “ROBUST INTERCONNECT STRUCTURE,” a multilayered barrier and a layer of Al(Cu) are interposed between a layer of copper and a pad-limiting layer. The Al(Cu) and barrier layers provide for a robust interconnection of the copper to the C4 pads. A similar approach is taken in Costrini et al., for wirebond pad terminals, in U.S. Pat. No. 6,187,680, entitled “METHOD/STRUCTURE FOR CREATING ALUMINUM WIREBOND PAD ON COPPER BEOL.” However, the Al(Cu) and barrier layers do not allow for a decrease in the necessary bonding pressure, temperature, or ultrasonic energy required to bond a wire. Further, the method of forming the multilayered barrier plus Al(Cu) pad involves expensive lithographic and reactive ion etching (RIE) steps, which are undesirable.

In U.S. Pat. No. 6,323,128 issued to Sambucetti, et al., on Nov. 27, 2001, entitled “METHOD FOR FORMING CO—W—P-AU FILMS,” a quaternary alloy film of Co—W—P—Au is used as a diffusion barrier layer on a copper interconnect in a semiconductor structure. The quaternary alloy film is used as a diffusion barrier layer between the copper interconnect and the silicon substrate or SiO₂ dielectric layers. This is a self-aligned process, which avoids the undesirable lithographic and RIE steps discussed above. The quaternary alloy layer, however, is not used for facilitating wire bonding or reducing the bonding pressures, temperatures, or ultrasonic energy. Edelstein, et al., in U.S. Pat. No. 6,457,234 entitled, “PROCESS FOR MANUFACTURING SELF-ALIGNED CORROSION STOP FOR COPPER C4 AND WIREBOND,” describe alternative self-aligned metallurgies on Cu wirebond pads including In or Sn involved in an alloyed reaction with the Cu. The resulting surface is already in an alloy form, and does not facilitate in wirebonding by reducing pressure or energy to form the bond.

Since a reduction in the bond pressure during wire bonding would reduce the probability of cracks in the dielectric, and ultimately enhance reliability, it is desirable to develop a method and structure that can accommodate wire bonding while requiring less pressure, temperature, and energy than is accustomed in the prior art.

Bearing in mind the problems and deficiencies of the prior art, it is therefore an object of the present invention to provide an apparatus and method for providing a reliable wire bond on a semiconductor substrate.

It is another object of the present invention to provide an apparatus and method for reducing wire bonding pressures, temperatures, and energy.

A further object of the invention is to provide an apparatus and method for reducing micro cracks and other applied stresses to low-k dielectrics during wire bonding.

It is yet another object of the present invention to provide an apparatus and method for reducing the propensity of dielectric material to have mechanical failure during wire bonding.

Still other objects and advantages of the invention will in part be obvious and will in part be apparent from the specification.

### SUMMARY OF THE INVENTION

The above and other objects, which will be apparent to those skilled in art, are achieved in the present invention, which is directed to, in a first aspect, an apparatus for low-pressure wire bonding of an integrated circuit chip to a substrate, the apparatus comprising: a metallic interconnect within the substrate; and an alloy material between the interconnect and a metallic wire connected to the integrated circuit chip, the alloy material including a composition of the metallic wire material and alloying metal. The metallic interconnect includes copper. The alloy material comprises a low temperature material including Au—Sn or Au—In. A concentration of the Sn of the alloy material is used to vary the alloy material's melting point to be greater than that of the alloying metal. The metallic wire is comprised of gold.

In a second aspect, the present invention is directed to an apparatus for low-pressure wire bonding on a substrate, comprising: a metallic interconnect within the substrate, the metallic interconnect having a top, bottom, and sides, surrounded on the bottom and the sides with a metallic diffusion barrier layer; a metallic barrier cap over the copper interconnect, wherein at least a portion of the barrier cap is comprised of alloy material; and a metallic wire attached to the alloy material, such that the combination of the alloy material and material of the wire react to form an alloy bond. The metallic interconnect is comprised of copper. A passivation layer may be included over the barrier cap, wherein a portion of the passivation layer is then removed. The metallic wire attaches to the alloy material where the portion of the passivation layer is removed. The alloy material comprises a low temperature material including Au—Sn or Au—In. The alloy material melting temperature may be adjusted such that it is greater than that of the alloying metal's melting point. A concentration of the Sn of the alloy material is used to vary the alloy material's melting point to be greater than that of the alloying metal's melting point. The concentration of the Sn of the alloy material is further adjusted for lead-free wire bond attachments. The diffusion barrier includes TiN, TiW, W, Ta, TaN, Ni, NiP, CoP, or CoWP.

In a third aspect, the present invention is directed to a substrate for low-pressure wire bonding on a substrate, comprising: a metallic interconnect within the substrate, the interconnect having a top, bottom, and sides, surrounded on the bottom and the sides with a metallic diffusion barrier layer; a metallic wire having a body and endpoint, having a coating of an alloy material at least at the endpoint; the metallic wire attached to the interconnect such that the combination of the alloy material and the metallic wire material react to form an alloy bond with the interconnect.

In a fourth aspect, the present invention is directed to an apparatus for low-pressure wire bonding on a semiconductor substrate having a top surface, comprising: a copper interconnect within the substrate and below the top surface of the substrate, the copper interconnect having a top, bottom, and sides, surrounded on the bottom and the sides with a first metallic diffusion barrier layer; a first dielectric diffusion barrier layer over the copper interconnect top; a portion of the substrate over the copper interconnect removed, such that a portion of the copper interconnect is exposed; a second metallic barrier layer covering the substrate top surface and covering the exposed portion of the copper interconnect; an aluminum bond pad deposited within the removed portion of the substrate, over the exposed portion of the copper interconnect; a third metallic diffusion barrier over the aluminum bond pad; a layer of alloy material applied over the third barrier; a wire attached to the alloy material, such that the combination of the alloy material and material of the wire react to form an alloy bond. The apparatus further comprises: a composite silicon layer; and a polyimide layer; the composite silicon layer and the polyimide layer applied over the apparatus such that a portion of the alloy material layer is left exposed for attaching the wire. The composite silicon layer includes silicon nitride or silicon dioxide. The first barrier layer comprises silicon nitride, and the third diffusion barrier comprises TiN. The alloy material may comprise a low temperature material including Au—Sn or Au—In. The apparatus may further comprise adjusting a concentration of the Sn or In of the alloy material to vary the alloy material's melting point to be greater than that of the alloying metal's melting point.

In a fifth aspect, the present invention is directed to a method for forming a low temperature wire bond to a substrate, the method comprising: providing an interlayer dielectric having a copper interconnect therein, the copper interconnect surrounded on sides and bottom by a first metal diffusion barrier; applying a dielectric barrier cap to the copper interconnect top; removing a portion of the barrier cap; replacing the removed portion of the barrier cap with alloy material; applying a passivation layer and removing a portion thereof to make a gap to accept a wire bond; pressing a wire against the alloy material under pressure, temperature, and ultrasonic energy conditions for wirebonding, such that an alloy is formed of the combination of the alloy material and the wire material. The alloy material comprises a low temperature material including Au—Sn or Au—In. The diffusion barrier includes TiN, TiW, W, Ta, TaN, Ni, NiP, CoP, or CoWP.

In a sixth aspect, the present invention is directed to a method for forming a low temperature bond pad, the method comprising: providing a substrate having a copper interconnect therein, the copper interconnect surrounded on sides and bottom by a first metallic diffusion barrier; applying a dielectric barrier cap to the copper interconnect top; exposing a portion of the substrate, the barrier cap, and the copper interconnect; covering the exposed portions with a second metallic barrier layer; depositing an aluminum bond within the exposed portion; covering the aluminum with a third metallic barrier layer; applying an alloy material to the second barrier layer or a bond wire; pressing the bond wire against the alloy material under pressure, temperature, and ultrasonic energy conditions for wirebonding, such that an alloy is formed of the combination of the alloy material and the wire material. The alloy material comprises an alloying metal having a low temperature material including Au—Sn or Au—In. The alloy material may be applied to the second barrier layer and the bond wire. The method further includes coating an endpoint of the bond wire with the alloy material. The alloy material includes Sn or In.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts the addition of the alloying element cap of the present invention over a copper interconnect.

FIG. 2 depicts the alloying element cap of FIG. 1 with a wire bonded thereto.

FIG. 3 is a cross-section of a silicon dioxide (SiO2) substrate with aluminum via representing the bond pad to the copper interconnect.

FIG. 4 depicts the stacked aluminum structure of FIG. 3 with a wire bond attached, forming an alloy of the combination of alloy material and wire bond.

### DESCRIPTION OF THE PREFERRED EMBODIMENT(S)

In describing the preferred embodiment of the present invention, reference will be made herein to FIGS. 1-4 of the drawings in which like numerals refer to like features of the invention.

Dielectrics have poor mechanical strength and are subject to cracking. Wirebonding to a semiconductor can induce cracks/damage in the dielectric when stresses are applied. The cracking can result in reliability failures during use. The present invention details an apparatus and method for low-pressure wirebonding, which reduces the propensity of dielectric material to mechanical failure due to wirebond stress.

An approach is presented to increase the reactivity between the bond wire and the bond pad, thereby allowing for reduced pressure and ultrasonic and thermal energy during wirebonding. This approach is to use a metal alloy on top of the bond pad that reacts at low temperatures with the bond wire.

A low temperature alloying metal on the surface of the pad can allow bond formation to occur at reduced bond pressures. Preferred alloy materials include Sn, In, Au—Sn, or Au—In. Selective immersion plating of Sn on Cu is well known, and baths are commercially available by several suppliers. Selective immersion plating of In on Cu has been formulated by Edelstein, et al., in U.S. Pat. No. 6,358,832, entitled “METHOD OF FORMING BARRIER LAYERS FOR DAMASCENE INTERCONNECTS.” The Au—Sn alloy may be applied over the Cu bond pad incorporated into or on the surface of the bond wire, which is incorporated in an aluminum bond pad stack. The alloy may also be deposited on Ni—Au capped Cu bond pads, such as described by the method described in U.S. Pat. No. 6,368,484 issued to Volant, et al., on Apr. 9, 2002, or the method disclosed by Uzoh, et al., in U.S. Pat. No. 6,251,528 issued on Jun. 26, 2001. An appropriate diffusion barrier would be used between the Cu, Al, or Au, and the alloy. Some diffusion barrier layers include TiN, TiW, W, Ta, TaN, CoP, NiP, CoWP, and the like. In the case of Ni—Au pads, no barrier is needed as the Ni already serves as a barrier under the Au, which could be consumed as the Au wire is during alloy bonding formation. Material such as Sn or In could be selectively deposited in the course of the bond cavity process using electrolytic plating, or by immersion or electroless plating. The preferred thickness of the low temperature alloy is on the order of 250 nm, with an effective operating range of about 50 to 500 nm. The preferred thickness of the barrier is on the order of 50 nm, with a typical range of about 10 to 100 nm.

Adjusting the Sn or In concentration may vary the melting point of the alloy. For Sn concentrations above 50 at. % (atomic percent) the melting point of the Au—Sn alloy is approximately 217° C. For Sn concentrations below 50 at. %, the melting point of the alloy is approximately 278° C. The melting point of the alloy should be greater than that of the solder bumps used for the package. For eutectic SnPb solders with a melting point of 183° C., the melting point is lower than for any Au—Sn alloys. However, in Pb-free solders, such as Sn—Cu, a melting point of 227° C. is higher than that for Sn-rich, Au—Sn alloys. Therefore, when using Pb-free solders for the package level solder bumps, it is desirable to use Au-rich Au—Sn for the bond pad alloy.

FIG. 1 depicts the addition of the alloying element cap of the present invention over a copper interconnect. A dielectric substrate 10 is shown with a copper interconnect 12. The copper interconnect 12 is covered by a barrier cap 14 and passivation layer 16. The passivation layer 16 includes a gap 18 for placement of a wire bond (not shown). Attached to the barrier cap 14 or in place of a portion of the barrier cap is a low temperature alloying element cap 20. The alloying element cap 20 covers that portion of the copper interconnect 12 that would otherwise be exposed through gap 18 of the passivation layer 16.

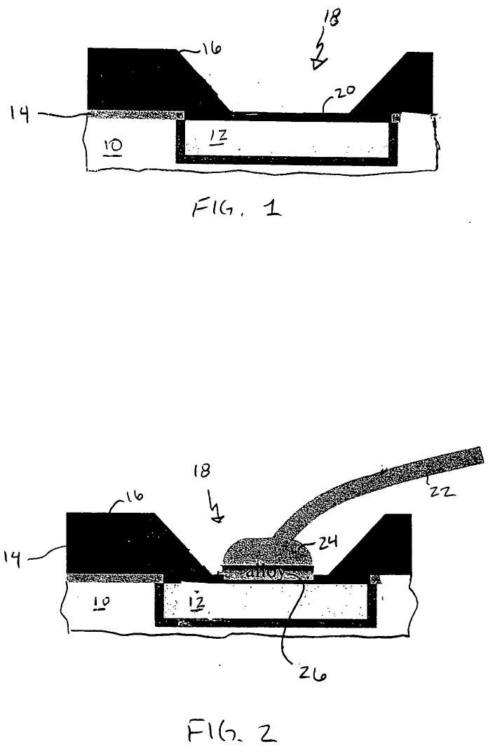

FIG. 2 depicts the alloying element cap 20 of the present invention with a wire 22 bonded thereto. Typically, the wire 22 will have a ball shaped end 24 for bonding, which flattens under pressure, temperature, and ultrasonic energy, towards the alloying element cap 20. Preferably, the wire 22 is gold, although other materials that can react with the alloying element cap may also be considered. When the Au wire is attached, the alloy material creates a resultant alloy 26 under temperature, pressure, and energy lower than that required for bonds that are not exposed to alloy material. The resultant alloy 26 provides for increased bonding strength. The alloy 26 is formed within the wire-alloy material interface.

FIG. 3 is a cross-section of a silicon dioxide (SiO₂) substrate 30 with aluminum via 32 representing the bond pad to the copper interconnect 34. A diffusion barrier layer 36 of silicon nitride (SiN) is applied over the copper interconnect. A portion of the SiN layer 36 is then removed and a TaN/Fi/TiN layer 38 is applied to seal the exposed copper interconnect. The aluminum bond pad or via 32 is deposited and capped with a second TiN layer 40 or similar refractory metal, metal alloy, or metal nitride barrier. Lithography and reactive ion etching process steps are used to define the Al(Cu) pad, etching through the pad and barrier stack to ultimately define the pad. The alloy material of the present invention is applied over the TiN cap. This could be done as a blanket film with the rest of the stack prior to lithography and RIE, or afterwards using a selective deposition process that only deposits on the exposed TiN regions. Preferably, a Sn, In, Au/Sn, or Au/In alloying layer 42 is deposited over the TiN cap 40. A protective dielectric layer, such as silicon nitride (SiN) 44, covers the stacked aluminum structure. A polymer passivation layer 46, such as polyimide, forms the top layer of the structure, which then has a portion removed to form a gap 48 for the wire bond.

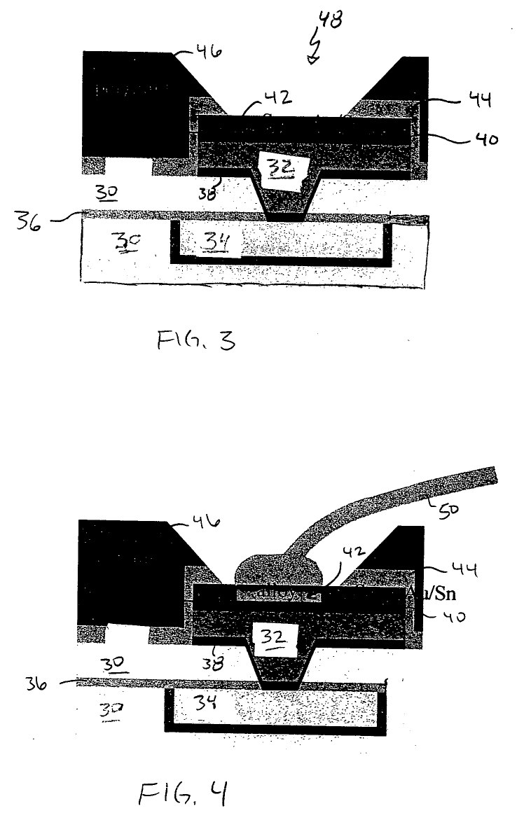

FIG. 4 depicts the stacked aluminum structure of FIG. 3 with a wire bond 50 attached, forming an alloy of the combination of alloy material 42 and wire bond 50. Once again, because of the alloying nature of the alloy material, a stronger bond is formed upon contact with the wire at lower temperature, pressure, and energy than that required for bonds without alloying reactive material.

One method for forming the alloying bond structure over a metal interconnect is performed by first providing an interlayer dielectric having a copper interconnect therein. The copper interconnect is usually surrounded on the sides and bottom by a diffusion barrier. On the copper interconnect top, a barrier cap is applied. A portion of the barrier cap is then removed and alloy material is used to replace it. In a second embodiment, the alloy material may represent the entire barrier cap. A passivation layer is used to cover the top, and a portion is removed, making a gap to accept a wire bond. The wire is pressed against the alloy material cap under pressure, temperature, and ultrasonic energy conditions for wirebonding, where an alloy is formed of the combination of the alloy material and the wire material.

The method for forming the bond exhibited in FIGS. 3 and 4, requires an aluminum bond pad inserted within the SiO₂ substrate, such that the aluminum is in contact with the copper interconnect. A TiN layer is then deposited, covering the aluminum pad. Alloy material is applied to the TiN layer. A protective nitride layer is then applied and covered by a polyimide. A portion of the polyimide is removed, making a gap to accept a wire bond. Once again, the wire is pressed against the alloy material cap under pressure, temperature, and ultrasonic energy conditions for wirebonding, where an alloy is formed of the combination of the alloy material and the wire material.

Yet another way of forming an alloy wirebond is by dipping the tip of the Au wire in a pot of liquid alloying metal immediately prior to bonding to the existing Cu or Al pad. Excess alloying metal will react with existing bond pad and Au wire.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. An apparatus for low-pressure wire bonding of an integrated circuit chip to a substrate, said apparatus comprising:
a metallic interconnect within said substrate; and
an alloy material between said interconnect and a metallic wire connected to said integrated circuit chip, said alloy material including a composition of said metallic wire material and an alloying metal.

2. The apparatus of claim 1 wherein said metallic interconnect includes copper.

3. The apparatus of claim 1 wherein said alloy material comprises a low temperature material including Au—Sn or Au—In.

4. The apparatus of claim 3 wherein a concentration of said Sn of said alloy material is used to vary said alloy material's melting point to be greater than that of said alloying metal.

5. The apparatus of claim 1 wherein said metallic wire is comprised of gold.

6. An apparatus for low-pressure wire bonding on a substrate, comprising:
a metallic interconnect within said substrate, said metallic interconnect having a top, bottom, and sides, surrounded on said bottom and said sides with a metallic diffusion barrier layer;
a metallic barrier cap over said metallic interconnect, wherein at least a portion of said barrier cap is comprised of alloy material; and
a metallic wire attached to said alloy material having alloying metal, such that the combination of said alloy material and material of said wire react to form an alloy bond.

7. The apparatus of claim 6 wherein said metallic interconnect is comprised of copper.

8. The apparatus of claim 6 further comprising a passivation layer over said barrier cap, wherein a portion of said passivation layer is removed.

9. The apparatus of claim 8 wherein said metallic wire attaches to said alloy material where said portion of said passivation layer is removed.

10. The apparatus of claim 6 wherein said alloy material comprises a low temperature material including Au—Sn or Au—In.

11. The apparatus of claim 6 wherein said alloy material melting temperature is adjusted such that it is greater than that of said alloying metal.

12. The apparatus of claim 10 wherein a concentration of said Sn of said alloy material is used to vary said alloy material's melting point to be greater than that of said alloying metal.

13. The apparatus of claim 12 wherein said concentration of said Sn of said alloy material is further adjusted for lead-free wire bond attachments.

14. The apparatus of claim 6 wherein said diffusion barrier includes TiN, W, TiW, Ta, TaN, Ni, NiP, CoP, or CoWP.

15. The apparatus of claim 6 wherein said metallic wire is comprised of gold.

16. A substrate for low-pressure wire bonding on a substrate, comprising:
a metallic interconnect within said substrate, said interconnect having a top, bottom, and sides, surrounded on said bottom and said sides with a metallic diffusion barrier layer;
a metallic wire having a body and endpoint, having a coating, at least at said endpoint, of an alloy material comprising alloying metal;
said metallic wire attached to said interconnect such that the combination of said alloy material and said metallic wire material react to form an alloy bond with said interconnect.

17. An apparatus for low-pressure wire bonding on a semiconductor substrate having a top surface, comprising:
a copper interconnect within said substrate and below said top surface of said substrate, said copper interconnect having a top, bottom, and sides, surrounded on said bottom and said sides with a first metallic diffusion barrier layer;
a first dielectric diffusion barrier layer over said copper interconnect top;
a portion of said substrate over said copper interconnect removed, such that a portion of said copper interconnect is exposed;
a second metallic barrier layer covering said substrate top surface and covering said exposed portion of said copper interconnect;
an aluminum bond pad deposited within said removed portion of said substrate, over said exposed portion of said copper interconnect;
a third metallic diffusion barrier over said aluminum bond pad;
a layer of alloy material including alloying metal applied over said third barrier;
a wire attached to said alloy material, such that the combination of said alloy material and material of said wire react to form an alloy bond.

18. The apparatus of claim 17 further comprising:
a composite silicon layer; and
a polyimide layer;
said composite silicon layer and said polyimide layer applied over said apparatus such that a portion of said alloy material layer is left exposed for attaching said wire.

19. The apparatus of claim 18 wherein said composite silicon layer includes silicon nitride or silicon dioxide.

20. The apparatus of claim 17 wherein said first barrier layer comprises silicon nitride, and said third diffusion barrier comprises TiN.
